(19) United States
(12) Patent Application Publication
(10) Pub. No.: US 2016/0080785 A1
(43) Pub. Date: Mar. 17, 2016

(54) Method For Determining Availability Time Period For A Media Episode

(71) Applicant: ANGL TECHNOLOGIES HUNGARY KFT., Balatonfüred (HU)

(72) Inventor: Andras Kovecs, Budapest (HU)

(73) Assignee: ANGL Technologies Hungary Kft., Balatonfured (HU)

(21) Appl. No.: 14/890,057

(22) PCT Filed: Dec. 10, 2013
(86) PCT No.: PCT/HU2013/000121

§ 371 Date: Nov. 9, 2015

(30) Foreign Application Priority Data
May 10, 2013 (HU) P1300305

(51) Int. Cl. H04N 21/254; H04N 21/2187; H04N 21/442; H04N 21/4627

(52) U.S. Cl. CPC H04N 21/2541; H04N 21/4627; H04N 21/2187; H04N 21/442

(57) ABSTRACT

The invention relates to a method for determining the availability time period (AT) of a media episode, comprising the steps of broadcasting a media episode for a playing time period (L), making available the media episode for playback for an availability time period (AT) after the playing time period (L) has elapsed, and determining the availability time period (AT) based on at least one extension time period (E1, E2, E3, E4) corresponding to at least one extension request taken in relation to the media episode during the playing time period (L) or during the availability time period (AT) by at least one user.

### TECHNICAL FIELD

The invention relates to a method for determining availability time period for a media episode, preferably originating from a live broadcast. A media episode is a given-length portion of any type of media material (video, audio, 3D content or other information content).

### BACKGROUND ART

More and more media distribution systems intended for providing live broadcasts are becoming operational nowadays. A survey of the prior art of such systems is provided in Hungarian patent specification P 11 00468. The document discloses a system allowing a user to connect to live broadcasts, and, in specific cases, to give instructions to the person providing the broadcast on the desired specifics of the broadcast to be viewed. It is mentioned in the document that an unlimited number of non-controlling users may connect to a broadcast provided by a so-called non-controllable broadcaster. According to the solution disclosed at the webpage http://www.livestream.com/guide/livetv, live broadcasts are made available for viewing over the internet.

There are also known systems which allow the expression of opinion on media content. According to the disclosure of US 2007/0154168 A1, individual segments of a segmented media program are evaluated on the basis of the interest of a given user or a community of users in it, the obtained results being tabulated and the preferences displayed.

In US 2007/0169148 A1 methods are disclosed for displaying content recommendations to a user viewing a given media content based on the user's own profile or by monitoring the preferences of several users.

A multi-user system is disclosed in U.S. Pat. No. 8,099,334 B1, wherein users may vote for/against each music track as it is being played. The preferences thus surveyed are later utilised for compiling playlists and for determining the users' favourites.

In U.S. Pat. No. 8,271,334 B1 a system is disclosed wherein certain media contents are bookmarked or selected for future availability. According to the document, based on user preference data the system notifies users when potentially interesting content becomes available. The content may then be bookmarked so that it will remain available later on.

A solution for providing real-time popularity feedback on items of information content is disclosed in US 2003/0037140 A1. According to US 2013/0007045 A1 users are fed further content based on the content previously viewed by them. In US 2009/0133048 A1 a system is disclosed wherein video content is automatically rated based on certain user actions. A media distribution system is disclosed in U.S. Pat. No. 7,996,482 B1. In EP 1570700 B1 a method for detecting multi-user behaviour is disclosed. A media distribution system is disclosed in US 2009/0138925 A1. In the system according to the document, availability can be requested for a media item, and, in case the availability time period proves to be too short, an extension request can be taken.

Furthermore, an internet application called “YouNow” is known. The application allows users to provide online live broadcasts. According to the rules of the application, other users vote period-by-period for or against the continuation of the given user's live broadcast. In case there are more positive feedbacks than negative during a period of one minute, the user is allowed to continue the live broadcast. The application supports searching for new talent in the field of performing arts. Since at the beginning of their live broadcast the performers do not know how long their performance will last, this application essentially evaluates the improvisation skills of the performers. Performances are basically rated by users who are themselves waiting for an opportunity for live broadcasting, and who get the opportunity only when a given live broadcaster cannot continue his broadcast due to the high number of negative votes. The application has a significant drawback that, instead of making available highly interesting broadcasts for a long period of time, it essentially provides tools for limiting the length of live broadcasts.

In view of the known solutions, a need has arisen to provide a method for determining availability time period of a media episode wherein the availability time period of the media episode is determined by the interest of one or more users, preferably by the interest of a user group or user community.

### DESCRIPTION OF THE INVENTION

The primary object of the invention is to provide a method which is free of the disadvantages of the prior art solutions to the greatest possible extent.

A further object of the invention is to provide a method for determining availability time period of a media episode wherein the availability time period of the media episode is determined by the interest of one or more users, preferably by the interest of a large user group or user community.

A yet further object of the invention is to provide a method that extends the possibilities of existing solutions for broadcasting, especially for providing live broadcasts available on-line.

The objects of the invention can be achieved by the method according to claim 1. Preferred embodiments of the invention are defined in the dependent claims.

The method according to the invention can be applied for media episodes related to broadcasts. The media episodes may be self-contained units or independent units—i.e. that can be rated independently—of a media item. The media episode is preferably transmitted to the user over a one-way (simplex) audiovisual channel. According to the invention, the availability time period of a given segment of a broadcast—the media episode—implemented applying video or audio streams or other technology is determined based on the ratings given by users—i.e. in case of a video stream, viewers—of the media item. In the method according to the invention, a user may request the extension in connection with a media episode; by taking his extension request (vote or rating), the user may extend the availability time period of the media episode by an extension time period. This means that, by taking an extension request, the user (viewer) of the media item is able to attain that the availability time period of the particular media episode is extended, i.e. that it may remain available for a prolonged period of time after the playing time period of the broadcast. In case a plurality of users take extension requests for a given media episode, i.e. express their interest therein, the media episode may remain continuously available for a very long period of time.

According to the inventive method, during the period a media episode is broadcasted (during the playing time period), users may join the broadcast real-time, that is, for instance they may continue viewing a video stream from a given instant of time or from a given scene. After the playing time period has elapsed, a recording of the media episode is available for viewing during the availability time period determined on the basis of the extension time period or periods, either in its entirety or from a selected scene. During the availability time period the media episode is therefore available for playback.

The method according to the invention is significantly different from the above described YouNow application, both in its implementation and its objects.

The method according to the invention relates to a media episode having a specific, fixed length, the method being targeted at determining the availability time period of this fixed-length media episode. The availability time period is determined based on the extension request or requests taken (submitted) by one or more users, as well as on the extension time periods corresponding thereto. During the availability time period the given media episode is available for playing, implying that the broadcast has already ended by this time, the availability time period follows the playing time period without overlapping with it. Thereby, according to the invention a given media episode—a media item such as a video of an interesting event or phenomenon, or audio material of an interesting talk—may be rated by users, and, through their extension requests, be made available for further playback.

Conversely, in the YouNow application availability time period cannot be interpreted. As long as a live broadcast is in progress, its duration may be interpreted as belonging to the playing time period, the future of completed broadcasts not being determined by the users' votes, as broadcasts are not certainly recorded in all cases for future playback. Therefore, the concept of availability time period is missing from this scheme. In the YouNow application live broadcasts end precisely because there is no more interest in them, the goal being keeping a live broadcast “alive” (the duration of the live broadcast is therefore variable) rather than making media episodes of fixed duration available for playback. In the method according to the invention a media episode will be available after the playing time period provided that an extension request has been taken for it. Therefore, the availability time period of the episode is determined by the extension requests taken during the (non-overlapping) playing time period and availability time period.

### BRIEF DESCRIPTION OF THE DRAWINGS

Preferred embodiments of the invention are described below by way of example with reference to the following drawings, where

FIG. 1 is a drawing of the playing time period and multiple extension time periods in an embodiment of the method according to the invention,

FIG. 2A is a drawing of a subcase of an embodiment of the method according to the invention,

FIG. 2B is a drawing of a further subcase of an embodiment of the method according to the invention, and

FIG. 2C is a drawing of a still further subcase of an embodiment of the method according to the invention.

### MODES FOR CARRYING OUT THE INVENTION

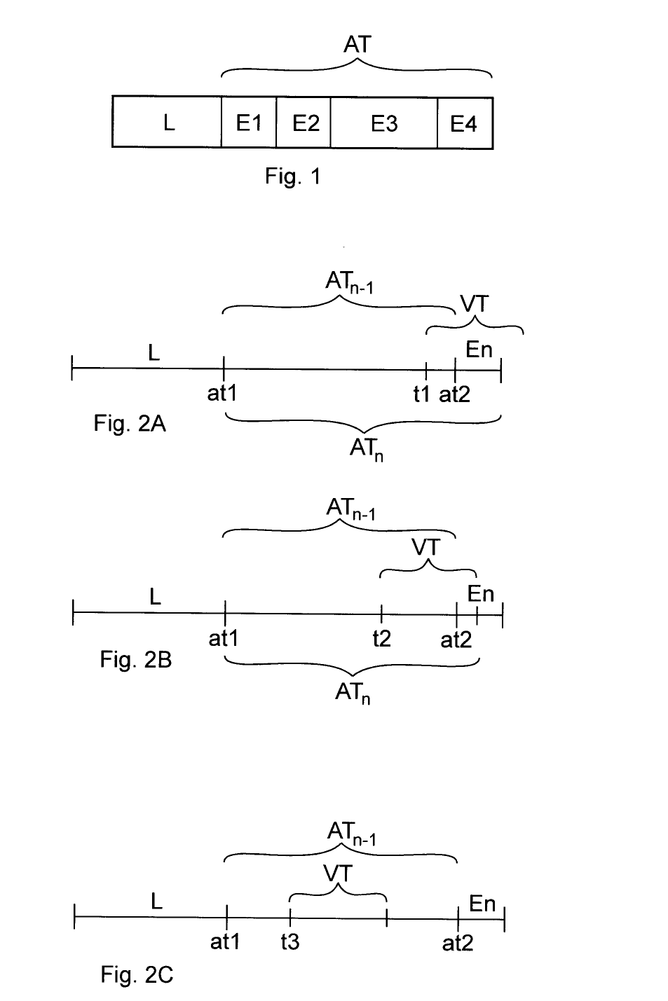

The method according to the invention is adapted for determining availability time period of a media episode. An embodiment of the method will be described referring to FIG. 1. In FIG. 1 a playing time period L, extension time periods E1-E4, and availability time period AT belonging to a media episode are illustrated. In the course of the method according to the invention a media episode is broadcasted for a playing time period L, the media episode is made available for playing for an availability time period AT after the playing time period L has elapsed, and the availability time period AT is determined based on extension time periods E1, E2, E3, E4, En corresponding to extension requests taken in relation to the media episode during the playing time period L or the availability time period AT by at least one user. In the embodiment shown in FIG. 1, the availability time period is obtained as the sum of the extension time periods E1-E4, but this is not the case in all embodiments. According to the embodiment of FIG. 1, the availability time period is longer than the playing time period. In case several extension requests are taken, the playing time period may amount to only a fraction of the availability time period.

As it is shown in FIG. 1, the length of the extension time period may vary, the extension time periods E1-E4 being different in length. The length (value) of the extension time periods is affected by several factors that will be described in detail below. Individual extension time periods are added to the availability time period of the media episode in a FIFO (first in, first out) manner, that is, the extension requests are evaluated in the order they are received, the order being also preserved when the extension time periods are taken into account. The length value of the extension time period may be specified by the user, but, as it will be detailed later, it may also be dependent on other parameters.

The broadcasted media episode may be obtained from an arbitrary source; according to the invention a media episode belonging to a live broadcast is preferably broadcasted. The method according to the invention may of course be applied for media episodes of other types or obtained from other sources; not only live content may be suitable for being made available for playback—based on the extension requests taken by users—for a long time after the playing time period has elapsed, that is, for being assigned even very long availability time periods based on the related extension time periods.

FIGS. 2A-2C the cases that arise in a preferred embodiment of the invention are illustrated. In the present embodiment, an extension time period En having a validity time period VT is applied. Thereby, in this embodiment a validity time period is assigned to each extension time period. If the time remaining from the availability time period of the media episode at the time instant when the extension request is taken (that is, when interest in it is expressed) is longer than the validity time period of the given extension time period, then it is not possible to extend the availability time period of the media episode by the given extension time period. According to this embodiment, three different cases arise as a result of the interrelation of the extension time period, the validity time period, and the time remaining from the availability time period when a given extension request is taken. These cases are illustrated in FIGS. 2A, 2B and 2C, respectively.

The first case is illustrated in FIG. 2A. In this case the value ATₙ of the availability time period is calculated, when an extension request belonging to the extension time period En is given, by adding the extension time period En corresponding to the given extension request to the current value ATₙ₋₁ of the availability time period if the validity time period VT of the given extension time period En is longer than the sum of the time remaining from the current availability time period ATₙ₋₁ and the given extension time period En.

For the sake of clarity, in FIGS. 2A-2C only the time of taking the extension request (respectively, t1, t2, and t3 in FIGS. 2A, 2B, and 2C) is modified, leaving all the other parameters unchanged.

It is shown in FIG. 2A that the validity time period VT, being counted from the submission time t1 of the extension request corresponding to the extension time period En, lasts longer than the sum of the availability time period (ATₙ₋₁) current at the given time and the extension time period En. Thereby, the availability time period value ATₙ₋₁ can be extended by the extension time period En, and thus the new value of the availability time period, in this case ATₙ=ATₙ₋₁+En, can be obtained. To summarize the above detailed case, the above formula may be used for obtaining the new value of the availability time period in case the extension time period has such validity time period that the given extension time period is still valid at the end of the new availability time period.

The next case is illustrated in FIG. 2B. In this case, the extension request corresponding to the extension time period En is taken at time t2, implying according to the figure that the validity time period VT would not last until the end of the availability time period extended by the extension time period En. In this case the next value ATₙ of the availability time period is obtained by adding the difference of the validity time period VT of the given extension time period En and the time remaining from the current length value ATₙ₋₁ of the availability time period to the current value ATₙ₋₁ of the availability time period. In this case, therefore, the validity time period VT of the given extension time period En is longer than the time remaining from the current value ATₙ₋₁ of the availability time period and is shorter than the sum of the time remaining from the current value ATₙ₋₁ of the availability time period and the given extension time period En.

In the third case, illustrated in FIG. 2C, the extension time period En is taken at time instant t3. As it is seen in FIG. 2C, in this case the validity time period VT is shorter than the time remaining from the current value ATₙ₋₁ of the availability time period. In this case, the current value ATₙ₋₁ of the availability time period is left unchanged, that is, ATₙ=ATₙ₋₁. This means that in this case taking the extension request corresponding to the extension time period En has no result (the availability time period is not extended) since the validity time period VT of the extension time period En elapses before the end of the availability time period. When the decision is made on extending the availability time period by the extension time period, the current value ATₙ₋₁ of the availability time period is taken into account.

In sum, according to the embodiment illustrated in FIGS. 2A-2C a given extension request can only be taken into account within the validity time period thereof. This preferred embodiment is intended to prevent that momentarily high but quickly decreasing interest in a media episode could unrealistically extend the availability time period of the given media episode. In this embodiment, therefore, the only way to extend the availability time period in a prolonged manner is by substantially continuously taking fresh extension requests indicating that there is prolonged interest in the given media episode. The typical value of the validity time period can be by way of example 14 days. The validity time period is typically much longer than the playing time period and the extension time period, and is comparable only to availability time period of suitable length.

In another embodiment of the invention also media episodes belonging to live broadcasts are broadcasted. According to this embodiment, multiple media episodes belonging to live feeds broadcasted from locations close to one another—locations closer to one another than a so-called group distance—are organised in a group, that is, are essentially assigned to a common event. In the present embodiment, the method according to the invention is carried out as follows—in accordance with the above details.

At least one additional media episode corresponding to at least one additional live broadcast located within a group distance from the location of the live broadcast and the media episode is taken into a group of media episodes. The group of media episodes therefore comprises the initial media episode, as well as additional media episodes located in its vicinity, that is, within the group distance. The initial media episode essentially specifies a central location around which the broadcasts are grouped. The value of the group distance is preferably in the range of 100-2000 m, particularly preferably in the range of 300-700 m, and exemplary it is 500 m. The grouping of the episodes is independent of the source of the additional live broadcasts.

After the group of media episodes is specified, the steps of the method according to the invention are carried out on the whole group of media episodes rather than on a single media episode. Thus, the following steps are carried out. The group of media episodes is broadcasted for a common playing time period. The playing time periods of individual media episodes at least partially overlap within the common playing time period. This means that a playing time period has not elapsed when the next one starts; such a time instant may preferably be specified for the media episodes assigned in the group which falls in the playing time period of all of the media episodes. Later on, such media episode may also be taken into the group that starts during the common availability time period of the group.

The common playing time period is preferably calculated as the union of the respective playing time periods of the media episodes corresponding to the group of media episodes. This implies that as long as there is even a single media episode in the group of which the playing time period has not elapsed the group of media episodes is broadcasted collectively.

According to the method, after the common playing time period has elapsed, the group of media episodes is made available for playback for a common availability time period. In the above described preferred embodiment therefore the common availability time period begins when the playing time period of all the media episodes in the group has elapsed. Naturally, those media episodes of the group that have ended during the common playing time period may of course be made available for repeated playback during the common playing time period itself.

In the present embodiment, the common availability time period is determined during the common playing time period and the common availability time period based on at least one extension time period corresponding to at least one extension request taken by at least one user in relation to one or more media episodes belonging to the group of media episodes. Thereby, according to this preferred embodiment an extension request taken for a single member of the group of media episodes may be sufficient for extending the common availability time period. Extension requests may of course be simultaneously taken for multiple members of the group.

When a given extension request is taken, the extension of the availability time period may be calculated also in this embodiment as depicted in FIGS. 2A-2C since they illustrate the effect of a single extension request. In the present embodiment the scope of an extension request covers not only a single media episode but rather a group of media episodes, i.e. it is the common availability time period of the group that can be extended as illustrated in FIGS. 2A-2C.

Also, in this embodiment an initial availability time period is preferably assigned to the group of media episodes, and the common availability time period of the group of media episodes is calculated by adding the common availability time period determined for the group of media episodes to the initial availability time period. The initial availability time period thus assigned to the group extends the common availability time period calculated on the basis of the extension requests to provide a default availability time period. The value of the initial availability time period is preferably in the range of 1-10 hours, particularly preferably 1-5 hours, and exemplary it is 3 hours.

In the present embodiment, additional media episodes created during the playing time period and during the availability time period of the group of media episodes within a group distance measured from the location of the live broadcast are preferably also taken into the group of media episodes. Thereby, media episodes belonging to the newly started live broadcasts are preferably also taken into the group of media episodes.

In addition to the spatial distance between the live broadcasts (the group distance), other parameters may also be considered during the (preferably automatic) process of creating the group of media episodes. Of course, only the media episodes of live broadcasts with overlapping playing time periods can be taken into the same group. In addition to that, other meta-information, such as the technical parameters of the broadcasts, user-related information, semantic properties of the broadcasts, or a combination of such meta-information may also be considered as organising principle. Other information related to the broadcast-providing users and viewers/listeners of the broadcast, as well as to users taking the extension requests may also play a role in the grouping.

The media episodes belonging to the group are preferably displayed in a collective manner, either by combining the content of the broadcasts, or treating the broadcasts as a logical unit in the displayed user interface.

In an embodiment of the invention the availability time period of the media episode may be modified according to geographical distance. According to this embodiment, a distance initial time period is specified as a function of the distance from the location of the live broadcast, and the common availability time period is calculated by adding the distance-dependent initial time period to the common availability time period. Thereby, a default time period yielding the initial value of the availability time period is specified as a function of the distance from the location of the live broadcast, which is incremented by the increments resulting from extension requests taken by the users. Preferably, the distance initial time period increases monotonously as the distance from the location of the live broadcast increases. This is advantageous because at locations that are physically closer to the location of the live broadcast it is easier to learn of the broadcasted event, and therefore it would be disadvantageous for users residing physically further away if they did not have enough time to learn of the given media episode so that they can take their extension request. This disadvantage is augmented also by time zone differences. The distance initial time period may be increased with distance in a continuous or gradual manner, or for instance by taking into account the time zones. In case of gradual increase, for instance the following values may be applied: within a range of 500 meters the distance initial time period is 5 minutes, and between 500 m and 10 km it is 15 minutes. A possible implementation of increments with regard to time zones is the following: in case viewer is in the same time zone as the location of the live broadcast, the distance-dependent initial time period is 1 hour, for a difference of 1 time zone it is 2 hours, . . . , and for a difference of 12 time zones it is 24 hours, that is, always twice the time zone shift.

The broadcast may preferably be viewed/listened to by anyone utilising a device adapted for displaying a media episode. Preferably, the broadcast is made available over the internet, for instance in a format similar to the formats applied by video sharing sites. The broadcast may be freely available or may be made available only after registration. In an embodiment of the invention, a request for a live broadcast of a first location is received from at least one user prior to starting the broadcast, and/or a broadcast intention for a live broadcast from a second location is received from at least one broadcast-providing user. Preferably, a notice of request is also sent to a broadcast-providing user residing at a requested location.

This may be implemented by that the user intending to view a live broadcast uses a map interface to select those locations from where he/she would like to watch live broadcasts. Later on, the user is preferably notified when such a live broadcast becomes available for viewing.

Users may also indicate their intention to start a broadcast utilising their devices adapted for providing broadcasts. These users receive a notification as soon as they enter an area from where other users are expecting a broadcast. When the user starts the broadcast, other users who are waiting for it are notified immediately so that they can view the live broadcast.

Taking the extension request by the user may be implemented in a number of ways. One of these is the so-called indirect mode. In this case, the user takes the extension request in an automatic manner, that is, the user's interest is indicated in an automatic way. Criteria for taking the extension request may comprise reaching a threshold value of viewing/listening time, or some other unintentional user interaction (eye movement, physiological information, mood detection, etc.). The length of the extension time period taken in the indirect mode may for instance be determined by some measurable characteristics of detected interactions. The extension time period may be in linear proportion to the user's heart rate, or to the already viewed length of the media episode.

The extension request may also be taken in a direct manner. In this mode, the user takes his/her extension request that indicates his/her interest in the broadcast by making a certain gesture, or other well-defined interaction, such as by pressing a button. In addition to the simple indication (submission) of the requested extension time period, the desired length of the extension time period may be specified also in this mode. Another variant of taking an extension request in a direct manner is realised by performing an interaction not intended as an extension request. For instance, sharing the broadcast with other users, inviting other users, following the broadcaster of the given media episode or submitting a friend request to him/her may also generate an extension request.

The extension request may also be taken in a hybrid mode, i.e. utilising some combination of the indirect and direct modes. For instance, the length of the extension time period requested in the direct mode are modulated utilising information obtained in ways (e.g. through certain interactions) described in relation to the indirect mode.

In the method according to the invention a single extension request for a given media episode is preferably accepted from a given user. Thereby the disproportionately prolonged extension of the availability time period resulting from a large number of extension requests taken by the same user may be prevented. According to the invention, a given media episode is “kept alive” by the interest expressed in the form of extension requests from preferably a group of users. Therefore, it is expedient to determine the availability time period primarily on the basis of the collectively expressed interest of a group of users, since with a longer availability time period chances are higher that further users will also take extension requests for the given media episode, that is, the given media episode will more likely stimulate interest in a wider audience.

Accordingly, the extension time period is preferably set shorter, particularly preferably much shorter than the playing time period of the media episode. The length of the extension time period is therefore preferably between 1/100 and ⅓ of the playing time period, particularly between 1/25 and 1/15 thereof, for instance 1/20 of the playing time period. The typical length of the playing time period may be exemplary 20 minutes, and the typical length of the extension time period being 1 minute. As it can be seen from the ratio of the playing time period and the extension time period, a significantly long availability time period can only be achieved if a large number of users (several hundred, or even several thousand of them) take extension requests for a given media episode, thereby indicating community interest.

According to the type of the broadcast and to their playing time period, the live broadcasts that correspond to the preferred embodiments of the invention may be classified into two major groups:
1. The “ad hoc” broadcast scenario: In this case the broadcast is coming not from a fixed broadcast device but from an intermittently operated user device (such as a mobile phone). In case of the “ad hoc” broadcast scenario, the broadcast consists of exactly one media episode, and thereby the broadcast can be rated in its entirety, and its availability time period can be determined applying the method according to the invention utilising the extension requests taken for the media episode that constitutes the entire broadcast. In the “ad hoc” broadcast scenario the playing time period of the broadcast is typically short, for instance a few minutes.
2. The infrastructure broadcast scenario: In this case the broadcast is coming from a fixed broadcast device (such as a device installed at a fixed geographical location or even on a vehicle). Infrastructure broadcasts either consist of a single media episode, or may be divided into more than one episode. With such broadcasts it may happen that the beginning and end of the broadcast are not defined, that is, the broadcast can be regarded as continuous. In this case the broadcast needs to be divided into media episodes, for which the method according to the invention may be applied.

A typical scenario of applying the method according to the invention is an unscheduled, unexpected event that seems interesting for a user who decides to provide a live broadcast of it. Users observing (viewing/listening to) the broadcasts also find it interesting, and take extension requests for it, thereby allowing later availability to the broadcast for further users. The media episodes of broadcasts found relevant by users remain available for everyone until the current user group collectively decides that the broadcast is no longer relevant and does not take further extension requests for it, not favouring the “survival” of the broadcast any more. The broadcasts that are found interesting are thus in a constant “evolutionary race”, where only the relevant and the interesting can survive under a selection pressure expressed in the form of extension requests. In the method, therefore, only those media episodes receive extension requests that provide interesting and relevant content according to the users.

According to a conceivable arrangement for implementing the inventive method the media episodes are recorded in a temporary storage. When the extension time period for a given media episode elapses, the media episode is deleted from the temporary storage. The media episode may then get transferred to another storage, but it ceases to be available in a manner specified in the method according to the invention.

The invention is, of course, not limited to the preferred embodiments described in details above, but further variants, modifications and developments are possible within the scope of protection determined by the claims.

1. A method for determining availability time period (AT) for a media episode, comprising the steps of
broadcasting a media episode for a playing time period (L), characterized by
making available the media episode for playing for an availability time period (AT) after the playing time period (L) has elapsed, and
determining the availability time period (AT) based on at least one extension time period (E1, E2, E3, E4, En) corresponding to at least one extension request taken in relation to the media episode during the playing time period (L) or during the availability time period (AT) by at least one user.

2. The method according to claim 1, characterized by applying an extension time period (En) having a validity time period (VT), and by calculating, when a given extension request is taken, value of the availability time period (ATₙ) by
adding an extension time period (En) corresponding to the given extension request to a current value (ATₙ₋₁) of the availability time period in case the validity time period (VT) of the given extension time period (En) is longer than the sum of the time remaining from the current value (ATₙ₋₁) of the availability time period and the given extension time period (En), or
adding the difference of the validity time period (VT) of the given extension time period (En) and the time remaining from the current value (ATₙ₋₁) of the availability time period to the current value (ATₙ₋₁) of the availability time period in case the validity time period (VT) of the given extension time period (En) is longer than the time remaining from the current value (ATₙ₋₁) of the availability time period and is smaller than the sum of the time remaining from the current value (ATₙ₋₁) of the availability time period and the given extension time period (En), or
leaving the current value (ATₙ₋₁) of the availability time period unchanged in case the validity time period (VT) of the given extension time period (En) is smaller than the time remaining from the current value (ATₙ₋₁) of the availability time period.

3. The method according to claim 1 characterized by broadcasting a media episode belonging to a live broadcast.

4. The method according to claim 3, characterized by taking at least one additional media episode corresponding to at least one additional live broadcast located within a group distance from the location of the live broadcast and the media episode into a group of media episodes, and
broadcasting the group of media episodes for a common playing time period,
making available for playing the group of media episodes for a common availability time period after the common playing time period has elapsed, and
determining the common availability time period based on at least one extension time period (E1, E2, E3, E4, En) corresponding to at least one extension request taken in relation to one or more media episodes belonging to the group of media episodes during the common playing time period or the common availability time period by at least one user.

5. The method according to claim 4, characterized by calculating the common playing time period as the union of the playing time periods of the media episodes corresponding to the group of media episodes.

6. The method according to claim 4, characterized by assigning an initial availability time period to the group of media episodes, and calculating the common availability time period of the group of media episodes by adding the common availability time period determined for the group of media episodes to the initial availability time period.

7. The method according to claim 4, characterized by taking into the group of media episodes additional media episodes created during the playing time period and during the availability time period of the group of media episodes within a group distance measured from the location of the live broadcast.

8. The method according to claim 3, characterized by specifying a distance initial time period as a function of the distance from the location of the live broadcast, and calculating the common availability time period by adding the distance initial time period to the common availability time period.

9. The method according to claim 3, characterized in that, prior to the broadcast,
a request for a live broadcast of a first location is received from at least one user, and/or
a broadcast intention for a live broadcast from a second location is received from at least one broadcast-providing user.

10. The method according to claim 9, characterized in that a notice of request is sent to a broadcast-providing user residing at a requested location.

11. The method according to claim 1, characterized by accepting single extension request for a given media episode from a given user.

12. The method according to claim 1, characterized in that the length of the extension time period is preferably between 1/100 and ⅓ of the playing time period, particularly preferably between 1/25 and 1/15 thereof, the length of the extension time period being by way of example 1/20 of the playing time period.

13. The method according to claim 1, characterized in that a user may take an extension request
in an indirect manner, particularly by reaching a threshold value in viewing/listening time period of the media episode, or by means of unintentional user interaction, and/or
in a direct manner, particularly by performing a suitable gesture, by means of other specific interaction, or by pressing a button.
